(19) United States
(12) Patent Application Publication
(10) Pub. No.: US 2010/0061798 A1
(43) Pub. Date: Mar. 11, 2010

(54) PIVOT BEARING WITH ADJUSTABLE RESISTANCE

(76) Inventors: Austin Unsworth, Fort Mill, SC (US); Tom Benfield, Kings Creek, SC (US)

Correspondence Address: Beusse Wolter Sanks Mora & Maire, 390 N. ORANGE AVENUE, SUITE 2500, ORLANDO, FL, 32801, US

(21) Appl. No.: 12/208,874

(22) Filed: Sep. 11, 2008

(51) Int. Cl. F16C 11/10

(52) U.S. Cl. 403/223; 403/87

(57) ABSTRACT

Disclosed herein is an articulated arm (60) of a dental examination light having a pivot bearing (20) with an adjustable resistance feature. The pivot bearing (20) includes a split bushing (40) with first and second edges (42, 48) is mounted in a channel (28) in an interior diameter (23) of a housing (22). A ramp (30) forms an end of the channel. An axle (24) is rotatably mounted in the bushing. A setscrew (36) is mounted in the housing tangentially to the bushing. A cutout (46) in the bushing receives a portion of the setscrew. Turning the setscrew pushes a front end of the setscrew against an abutment (47) of the bushing, pushing the first edge of the bushing into the ramp, which redirects the first end of the bushing radially inward against the axle when the setscrew is tightened, thus providing bearing resistance adjustment. The tangential orientation of the setscrew minimizes housing thickness required for the setscrew.

### FIELD OF THE INVENTION

This invention relates to bearings for articulated arm joints, and particularly to a bearing with adjustable resistance on an articulated support arm for a dental light.

### BACKGROUND OF THE INVENTION

Dental examination lights are mounted on articulated arms that provide multiple rotation axes for flexible positioning of the light via bearings between arm segments. Each bearing requires a balance between ease of movement and maintenance of position. A resistance adjustment may be provided for each bearing in order to achieve and maintain an ideal resistance for each axis of rotation during years of use.

A bearing may include an axle in a bushing in a housing. Resistance adjustment may be provided by setscrew mounted in a radially-oriented threaded hole in the housing. Tightening the setscrew moves it inward against the bushing, distorting and/or offsetting the bushing against the shaft, thus increasing the turning resistance of the shaft. A disadvantage of this type of adjustment is that the housing must be much thicker to accommodate the radially-oriented setscrew hole than would otherwise be necessary for strength of the housing.

### SUMMARY OF THE INVENTION

The inventors realized that the bearing housing thickness could be reduced if the setscrew hole could be oriented tangentially to the bushing, rather than radially. They devised a tangential setscrew that pushes against a cutout in the bushing. A ramp in the housing converts tangential movement of the bushing into radial inward movement of a portion of the bushing, thus providing resistance adjustment.

### BRIEF DESCRIPTION OF THE DRAWINGS

The invention is explained in the following description in view of the drawings that show:

FIG. 1 is a sectional view of a pivot bearing according to aspects of the invention taken on a plane normal to the rotation axis

FIG. 2 is a perspective assembled view of a pivot bearing in a housing, in which the housing is shown as transparent.

FIG. 3 is a perspective view of a dental examination light supported on an articulated arm.

### DETAILED DESCRIPTION OF THE INVENTION

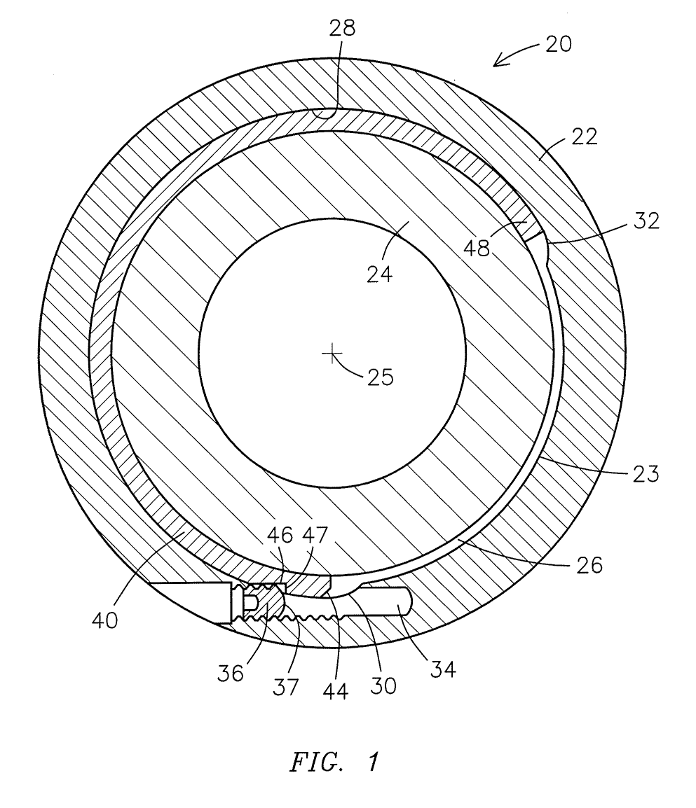

FIG. 1 shows a cross sectional view of a pivot bearing 20 with a split bushing 40 mounted in a channel 28 in the inner diameter 23 of a housing 22. The channel has a first end formed as a ramp 30 and has a second end 32. The bushing has first and second edges 42, 48. The first edge 42 has a ramp contact surface 44. A setscrew 36 is mounted tangentially to the bushing in a threaded hole 34 in the housing. A cutout 46 is provided in the bushing. The cutout 46 receives a portion of the setscrew such that a front end 37 of the setscrew contacts an abutment 47 on the bushing. Clearance 26 may be provided between the inner diameter of the housing and the bushing. An axle 24 is mounted rotatably within the bushing to rotate about an axis 25.

When the setscrew is turned in a tightening direction, it pushes tangentially against the abutment 47. This pushes the ramp contact surface 44 against the ramp 30, which pushes the first end 42 of the bushing radially inward against the axle 24, thus increasing the rotation resistance of the axle within the bushing. Since the setscrew is oriented tangentially, the threaded hole 34 requires much less radial thickness in the housing 22 than a radially-oriented setscrew. This reduces material cost, weight, and overall thickness of an articulated arm, such as those used for dental examination lights.

The bushing may be made of sintered bronze impregnated with oil, including a material known as Oilite®, or it may be made of another material. The threaded hole 34 has a side opening into the bushing channel 28. The side opening has a maximum opening width of less than half the diameter of the threaded hole 34, for example up to 30-40% of the threaded hole diameter, so that the setscrew is retained in the threaded hole. A thread gripping means such as a thread compound or plastic O-ring may be used on the setscrew to avoid accidental loosening of the setscrew during operation of the articulated arm. However, the setscrew will normally be in frictional contact with the abutment 47, which will also prevent loosening.

The ramp 30 may be curved as shown, or it may be straight. A curved ramp reduces the likelihood of binding of the contact surface 44 of the bushing between the ramp and the axle. It also reduces the likelihood of over-tightening the bushing because the mechanical advantage of the ramp decreases as the setscrew is tightened. A curved ramp may be formed for example by milling the channel 28 with a rotary milling tool, such that the ramp curvature is formed by the cutting diameter of the milling tool. Or it may be formed by other known means. The second end 32 of the bushing channel is also shown as curved. This exemplifies a milling method of forming the channel, but is not otherwise significant. The ramp contact surface 44 of the bushing may be beveled as shown or rounded.

The setscrew 36 may have a rounded end 37 as shown. This allows the setscrew to turn relatively smoothly against the abutment 47 at the end of the cutout 46 without grabbing the abutment with threads. Also, the contact angle of a curved end 37 with the abutment 47 provides a radially outward force component on the end of the setscrew that helps to retain the setscrew in the threaded hole 34.

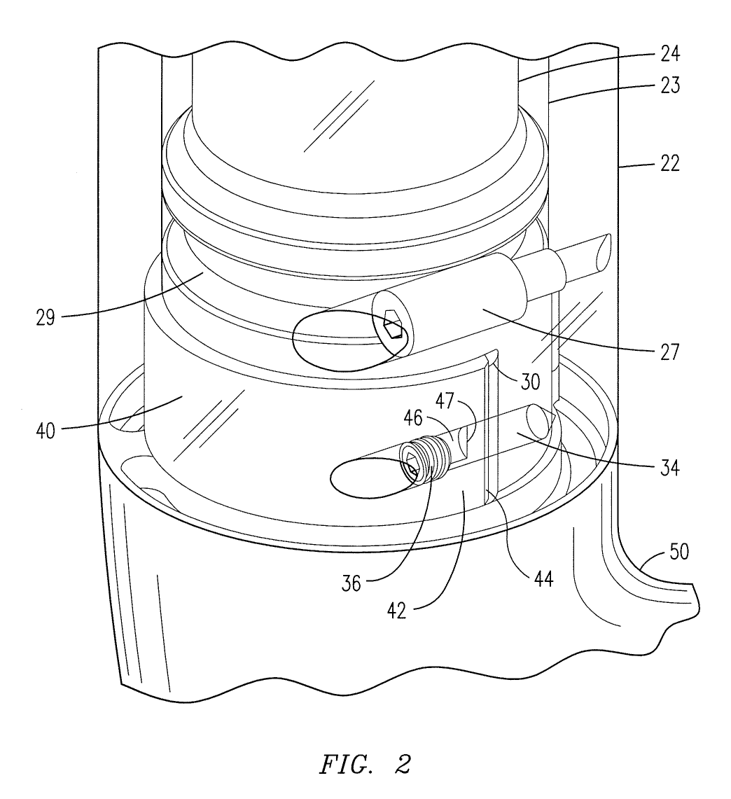

FIG. 2 shows a perspective view of a bearing as in FIG. 1 in a pivot joint between an articulated arm segment 22, which is the bearing housing, and an elbow 50 of the articulated arm. The housing 22 is shown as transparent, with an inner diameter 23. The split bushing 40 is a cylindrical tube that is split on one side to form the C-shaped cross section shown in FIG. 1. Most of the channel 28 in the housing for the split bushing is not visible in this view because it is transparent and follows the outline of the split bushing. However, the ramp portion 30 of the channel is visible separately from the contact surface 44 on the edge 42 of the split bushing. An axle retainer mechanism is shown in the form of a second tangential screw 27 in the housing, with a side that mates with an annular groove 29 on the axle. A second bearing, such as a non-adjustable bushing (not shown) may be provided at a second point on the axle to provide two-point support of the axle.

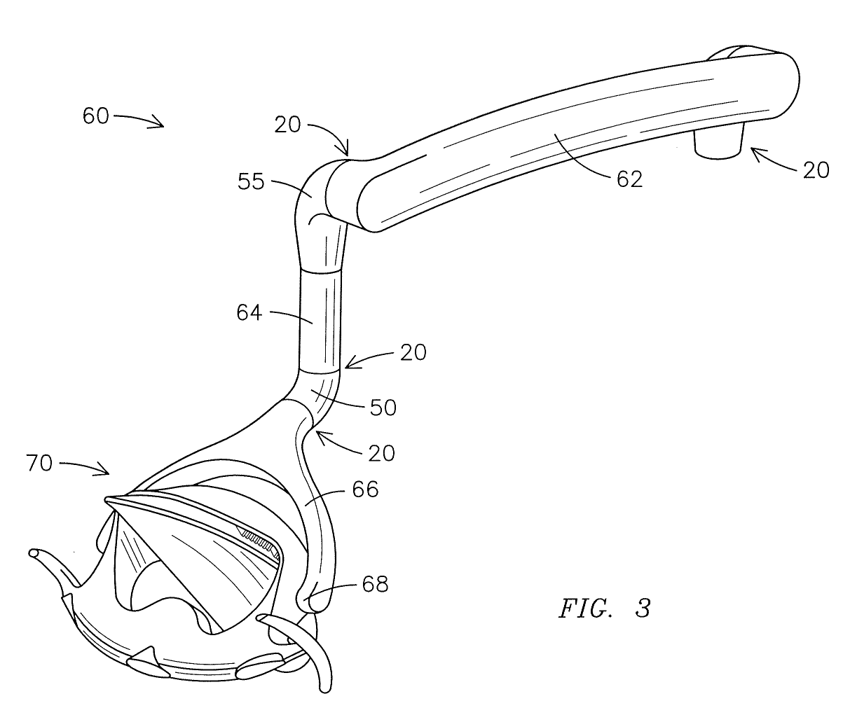

FIG. 3 shows a dental examination light 70 pivotally mounted at 68 in a yoke 66 on an articulated arm 60 formed of segments 62, 64 and elbows 50, 55. Four suggested joint locations for the present adjustable pivot bearing 20 are indicated, providing multiple axes of arm movement.

The figures show the abutment 47 and setscrew 36 near the first edge 42 of the bushing. However, this position is not an essential aspect of the invention. The abutment and setscrew may be some distance from the first edge 42 of the bushing, but is preferably within about 90° of the first edge. The cutout 46 is also not an essential aspect. An abutment 47 can be provided as a radially outward boss (not shown) on the bushing. However, such a boss is less compact and harder to fabricate than a preferred cutout as shown.

While one or more embodiments of the present invention have been shown and described herein, such embodiments are provided by way of example only. Variations, changes and substitutions may be made without departing from the invention herein. Accordingly, it is intended that the invention be limited only by the spirit and scope of the appended claims.

1-6. (canceled)

7. An articulated arm of a dental examination light having a pivot bearing with an adjustable resistance feature, the articulated arm comprising:
a generally cylindrical bearing housing having a threaded bore extending therethrough having a longitudinal axis extending generally tangentially to the inner diameter of the housing;
a split bushing mounted in the bearing housing at the inner diameter thereof;
an axle mounted rotatably within the split bushing;
a setscrew mounted in the threaded bore and movable generally tangentially to the split bushing in the housing;
a cutout in the bushing that receives a leading edge portion of the setscrew up to an abutment on the split bushing; and
a ramp in the housing that converts a tangential movement of a portion of the bushing into a radial movement of the portion of the bushing;
wherein tightening the setscrew pushes the portion of the bushing against the ramp, and the ramp redirects the portion of the bushing radially inward against the axle for increasing an axle rotation resistance;
whereby an axle rotation resistance adjustment is provided with minimal radial thickness of the housing required for the setscrew for enabling the arm to be selectively positioned and secured in a desired position and configuration.

8. The articulated arm of claim 7, wherein:
the split bushing comprises a substantially cylindrical tube with a split side, forming a generally C-shaped cross section with first and second edges;
the bushing is mounted in an annular channel in an inner diameter of the housing; and
the ramp forms an end of the annular channel.

9. The articulated arm of claim 8, wherein:
the setscrew is mounted in a threaded hole in the bearing housing, and the threaded hole is oriented tangentially to the split bushing at the cutout;
the threaded hole comprises a side portion that is open to the cutout;
a front end of the setscrew contacts the abutment; and
turning the setscrew in a first direction moves the setscrew forward tangentially against the abutment, which pushes a contact surface of the first edge of the split bushing into the ramp.

10. The articulated arm of claim 9, wherein the ramp has a curvature that is concave toward the setscrew, thus providing a decreasing mechanical advantage in converting the forward motion of the setscrew into radially inward motion of the contact surface of the first edge of the split bushing as the front end of the setscrew moves forward over the ramp.

11. The articulated arm of claim 9, wherein the ramp has a curvature that is concave toward the setscrew, the ramp being oriented substantially tangentially at a radially outer end of the ramp, and partly radially toward a radially inner end of the ramp.

12. The articulated arm of claim 9, wherein the setscrew has a rounded front end that contacts the abutment at an angle that provides a radially outward force component on the front end of the setscrew when the front end of the setscrew pushes into the ramp.

13. An articulated arm of a dental examination light having a pivot bearing with an adjustable resistance feature, wherein the pivot bearing comprises:
a split bushing with first and second edges mounted in a channel in an interior diameter of a housing;
a ramp forming an end of the channel;
an axle rotatably mounted in the bushing;
a setscrew mounted tangentially to the bushing in the housing; and
an abutment on the bushing;
wherein turning the setscrew in a tightening direction pushes a front end of the setscrew into the abutment, pushing the first edge of the bushing into the ramp, which redirects the first edge of the bushing radially inward against the axle, thus providing bearing resistance adjustment.

14. The articulated arm of claim 13, wherein the ramp has a curvature that is concave toward the setscrew, and provides a decreasing mechanical advantage in converting a forward motion of the setscrew into radially inward motion of the first edge of the split bushing as the front end of the setscrew moves forward over the ramp.

15. The articulated arm of claim 13, wherein the ramp has a curvature that is concave toward the setscrew, the ramp being oriented substantially tangentially at a radially outer end of the ramp, and partly radially toward a radially inner end of the ramp.

16. The articulated arm of claim 13, wherein the abutment is located on the split bushing within 90 degrees of the first end of the split bushing.

17. An articulated arm of a dental examination light having a pivot bearing with an adjustable resistance feature, the arm for an articulated arm of a dental examination light, the pivot bearing comprising:
a setscrew that acts tangentially on a split bushing in a housing, pushing an edge of the split bushing against a ramp in the housing that moves the edge radially inward against an axle in the bushing;
wherein moving the setscrew a forward direction increases a turning resistance of the axle in the bushing.

18. The articulated arm of claim 17, wherein:
the split bushing comprises a substantially cylindrical tube with a split side, forming a generally C-shaped cross section;
the split bushing is mounted in an annular channel in an inner diameter of the housing; and
the ramp forms an end of the annular channel.

19. The articulated arm of claim 18, wherein:
the setscrew is mounted in a threaded hole in the housing, and the threaded hole is oriented tangentially to the split bushing at a cutout in the split bushing;
the threaded hole comprises a side portion that is open to the cutout;
a front end of the setscrew contacts an abutment edge of the cutout; and
turning the setscrew in a first direction moves the setscrew forward tangentially against the abutment, which pushes a contact surface of the edge of the split bushing into the ramp.

20. The articulated arm of claim 19, wherein the ramp has a curvature that is concave toward the setscrew, and provides a decreasing mechanical advantage in converting the forward motion of the setscrew into radially inward motion of the edge of the split bushing as the front end of the setscrew moves forward over the ramp.

21. The articulated arm of claim 19, wherein the ramp has a curvature that is concave toward the setscrew, the ramp being oriented substantially tangentially at a radially outer end of the ramp, and partly radially toward a radially inner end of the ramp.

22. The articulated arm of claim 19, wherein the setscrew has a rounded front end that contacts the abutment at an angle that provides a radially outward force component on the front end of the setscrew when the front end of the setscrew pushes into the ramp.
